(19) United States
(12) Patent Application Publication
(10) Pub. No.: US 2008/0304590 A1
(43) Pub. Date: Dec. 11, 2008

(54) METHOD AND APPARATUS FOR TRANSMISSION FROM MULTIPLE NON-COLLOCATED BASE STATIONS OVER WIRELESS RADIO NETWORKS

(76) Inventors: Carl-Erik W. Sundberg, Sunnyvale, CA (US); Haralabos Papadopoulos, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/130,821

(22) Filed: May 30, 2008

Related U.S. Application Data
(60) Provisional application No. 60/942,350, filed on Jun. 6, 2007.

(51) Int. Cl. H04L 27/28

(52) U.S. Cl. 375/260

(57) ABSTRACT

A method and apparatus is disclosed herein for wireless transmission from multiple non-colocated antennas. In one embodiment, a wireless communication system comprises a controller to control a set of antenna elements dispersed over multiple, non-collocated base stations to wirelessly transmit information-bearing signals to one or more receivers using OFDM transmission, wherein control unit includes an antenna selection control operable to select non-collocated antenna elements from the set of antenna elements to send at least one signal to a receiver in the wireless communication system from antenna elements located at different base stations, and further wherein the OFDM transmission uses a circular prefix long enough to accommodate a maximum possible relative delay in reception between arrivals of the transmitted signals.

### PRIORITY

The present patent application claims priority to and incorporates by reference the corresponding provisional patent application Ser. No. 60/942,350, titled, “A Method and Apparatus for Efficient High Data Rate Wideband Transmission from Multiple Non-Collocated Base Stations over Wireless Radio Networks,” filed on Jun. 6, 2007.

### RELATED APPLICATIONS

This application is related to the co-pending U.S. patent application Ser. No. 12/121,634 entitled “Adaptive MaxLogMAP-Type Receiver Structures,” filed on May 15, 2008 and U.S. patent application Ser. No. 12/121,649, entitled “Adaptive Soft Output M-Algorithm Receiver Structures,” filed on May 15, 2008, both assigned to the corporate assignee of the present invention.

### FIELD OF THE INVENTION

The present invention relates to the field of wireless communication; more particularly, the present invention relates to wireless communication of a signal from non-collocated base stations to a receiver.

### BACKGROUND OF THE INVENTION

Future wireless systems require a more effective utilization of the radio frequency spectrum in order to increase the data rate achievable within a given transmission bandwidth. This can be accomplished by employing multiple transmit and receive antennas combined with signal processing. A number of recently developed techniques and emerging standards are based on employing multiple antennas at a base station to improve the reliability of data communication over wireless media without compromising the effective data rate of the wireless systems. So called space-time block-codes (STBCs) are used to this end.

Specifically, recent advances in wireless communications have demonstrated that by jointly encoding symbols over time and transmit antennas at a base station one can obtain reliability (diversity) benefits as well as increases in the effective data rate from the base station to each cellular user per unit of bandwidth. These multiplexing (throughput) gain and diversity benefits depend on the space-time coding techniques employed at the base station. The multiplexing gains and diversity benefits are also inherently dependent on the number of transmit and receive antennas in the system being deployed, in the sense that they are fundamentally limited by the multiplexing-diversity trade-offs curves that are dictated by the number of transmit and the number of receive antennas in the system.

In many emerging and future radio networks, the data for any particular cell user may be available to multiple base stations. Joint signaling from multiple base stations can readily extend the range/coverage of the transmission. Furthermore, viewing each of the base stations with data for a particular user as an element (or a group of elements in the case that multiple transmit antennas are present at each base station) of a virtual antenna array suggests using cooperative signal encoding schemes across these base stations to provide diversity benefits to the desired user. Since the encoded signals, however, are transmitted by spatially dispersed base-stations, they arrive at the receiver with distinct relative delays with one another, i.e., asynchronously. Although these relative delays can, in principle, be estimated at the receiver, they are not known (and thus cannot be adjusted for) at the transmitting base stations, unless there is relative-delay information feedback from the receiver to the transmitting base stations.

A large collection of STBCs have been proposed in recent years as a means of providing diversity and/or multiplexing benefits by exploiting multiple transmit antennas in the forward link of cellular systems. Of interest is the actual symbol rate of the STBC scheme, R, which is equal to k/t (i.e., the ratio of k over t). Full rate STBCs are STBCs whose rate R equals 1 symbol per channel use. Another important attribute of a STBC is its decoding complexity. Although the decoding complexity of the optimal decoder for arbitrary STBCs is exponential in the number k of jointly encoded symbols, there exist designs with much lower complexity. One such attractive class of designs, referred to as orthogonal space-time codes (OSTBCs), can provide full diversity while their optimal decoding decouples to (linear processing followed by) symbol-by-symbol decoding. Full rate OSTBCs exist only for a two transmit-antenna system. For three or more antennas, the rate cannot exceed ¾ symbols/per channel use. This rate is achievable for N=3 and N=4 antennas. As a result, although the imposed orthogonality constraint yields simple decoding structures, it places restrictions in the multiplexing gains (and thus the spectral efficiencies and throughput) that can be provided by such schemes.

A number of systems deployed for broadcasting common audio/video information from several base stations are exploiting coded OFDM transmission under the umbrella of the single frequency network concept. These systems employ a common coded OFDM based transmission from each of the broadcasting base-stations. The OFDM based transmission allows asynchronous reception of the multitude of signals and provides increased coverage. However, as all base-stations transmit the same coded version of the information-bearing signal, single frequency network (SFN) systems do not provide in general full transmit base-station diversity with full coding gains (some form of this diversity is available in the form of multi-path diversity, although limited since it is not coordinated). More importantly, they are not suited for providing very high data rates as only a single common coded stream is transmitted over every antenna.

A class of schemes that presents an alternative to the ones presented herein is presented for the collocated case in I. Lee, A. M. Chan, and C.-E. W. Sundberg, “Space-time bit-interleaved coded modulation for OFDM systems,” IEEE Transactions on Signal Processing, pp. 820-825, March 2004 and I. Lee and C.-E. W. Sundberg, “Code construction for space-time bit-interleaved coded modulation systems,” Proceedings of the IEEE International Conference on Communications (ICC '04), pp. 722-726, June 2004. These schemes are space-time bit-interleaved coded modulation systems with OFDM and can provide spatial (transmit and receive antenna) diversity, frequency diversity. Furthermore, by varying the rate of the outer code, these systems can trade off data rates with degree of provided space diversity. By modifying the binary convolutional code into rate compatible punctured convolutional codes, a flexible UEP system can be achieved. For these systems, it is assumed that all transmit antennas are collocated at one and the same base station.

### SUMMARY OF THE INVENTION

A method and apparatus is disclosed herein for wireless transmission from multiple non-colocated antennas. In one embodiment, a wireless communication system comprises a controller to control a set of antenna elements dispersed over multiple, non-collocated base stations to wirelessly transmit information-bearing signals to one or more receivers using OFDM transmission, where the controller includes an antenna selection control operable to select non-collocated antenna elements from the set of antenna elements to send at least one signal to a receiver in the wireless communication system from antenna elements located at different base stations. The OFDM transmission occurs with the use of a circular prefix long enough to accommodate a maximum possible relative delay in reception between transmissions from the antenna elements located at the different base stations.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of wireless communication system.

FIG. 2 is a block diagram of one embodiment of a transmitter for space-time coding with bit-interleaved coded modulation (BICM) with OFDM modulation for wideband frequency selective channels.

FIG. 3 is a block diagram of one embodiment of a receiver having an iterative decoder for the space-time code for the OFDM system.

FIG. 4 is a block diagram of one embodiment of MIMO demapper 305 having MIMO joint demapper units for the different OFDM tones/subchannels.

FIG. 5 illustrates one embodiment of a so called set partition type mapper.

### DETAILED DESCRIPTION OF THE PRESENT INVENTION

Embodiments of the present invention relate, in general, to signal design and to managing sending/receiving information over wireless systems, with multiple transmit antennas and, potentially, multiple receive antennas. In one embodiment, a mobile in a wireless communication system receives (by use of one or several antennas) a signal that is sent over multiple transmit antennas that are distributed over multiple base stations (i.e., they are not collocated).

In the disclosed techniques, each of the “active” base stations acts as an element in a virtual transmit antenna array, and standard space-time coding techniques are exploited for providing diversity and/or multiplexing gains (factor of increase in throughput) in these settings by treating each active base station as a transmit antenna. However, unlike the setting involving a single base station with multiple transmit antennas where the data is available at a single base station and can be encoded in a coordinated fashion over space and time to provide reliable transmission, in one embodiment, each active base station encodes its data independently. This is not a requirement for using the teachings described herein. In one embodiment, the controller communicates the information bearing stream to each base-station along with the coding parameters (rate of the outer code, initialization seed in the pseudorandom interleaver, constellation size, mapper lookup table, and possibly, FFT size and circular-prefix size, if these can vary). Then, once the antenna selection process is complete, the controller sends sets of pairs of numbers to each base station. Each such pair is of the form (x,y), implying that the stream produced for the xth antenna should be transmitted over physical antenna with index y at the given base station. In another embodiment, the central controller communicates to each base station pairs of the form (xth stream, physical antenna index y). The xth stream in this case could be the input or the output stream of mapper module (if it is the input, the controller should be make sure that the base station has available the mapper lookup table so as to be able to generate the associated output stream). One important consequence of this is that, in general, there can be a lack of precise time-synchronization between the transmissions from different base stations to the receiver due mainly to the fact that even if the signals the signals transmitted from spatially dispersed base stations to a receiver are transmitted synchronously, they may arrive asynchronously at the receiver.

Embodiments of the present invention include transmitters that wirelessly communication with receivers in systems that, for example, exploit intelligent wideband transmission of the information bearing signal over the multiple independently fading paths from each transmitting base station to a receiver, in such a way that it provides transmit base station diversity, the frequency diversity available in the transmission bandwidth, receive antenna diversity if multiple receive antennas are employed, and extended coverage. By varying the rate of the outer code, high data rates may be obtained with limited spaced diversity, full space diversity at lower data rates, as well as several points in between whereby rate is traded off with space diversity. Also the teachings described herein manage to deal with the asynchronous reception problem, by using a circular prefix long enough to accommodate the longest possible relative delays between signal receptions arriving from distinct antennas placed at distinct base stations. The selection, setting and use of a circular prefix are well-known in the art. Once a long enough prefix is selected, the use of OFDM accommodates for the multi-path spread and the asynchronous reception of signals.

Embodiments of the present invention are applicable to space time coding schemes for both systems with collocated base stations and non collocated base stations. Embodiments using the disclosed techniques can be viewed as providing the OFDM-based benefits of a single frequency network while at the same time allowing the frequency diversity and providing rate increases and/or transmit base-station diversity by using distinct coordinated transmissions from distinct base stations together with bit-interleaved coded modulation.

Embodiments of the present invention apply particularly well to all MIMO/OFDM based systems using bit interleaved coded modulation (BICM) with iterative decoding (ID). For a low rate outer binary code, these systems have full diversity. For a high rate code, high data rates can be achieved, but there is a reduction in the degree of space diversity. In one embodiment, wideband transmission is used with an outer binary convolutional code, which is based on bit-interleaved coded modulation. The rate of the outer code indirectly determines the degree of space diversity in the system. It is also an important factor in determining the data rate of the system. The proposed methods also make provisions for optional flexible unequal error protection for media signals.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

A class of space-time coding techniques and associated transceivers are described for enabling reliable high-rate transmission of common information from a set of base stations to one or more receivers over wideband wireless channels. For the purpose of extending coverage and opportunistically providing data rate increases and/or additional diversity, a signal is transmitted over a number of transmit antennas distributed over multiple base stations. In one embodiment, transceivers achieve reliable transmission of a common information signal by sending distinct encodings from each antenna at each base station without the need for fully synchronizing the transmissions. This is achieved by exploiting a long enough circular prefix in the system that can accommodate the longest possible relative delays of paths emanating from distinct antennas at distinct base stations. A disclosed method results in schemes that provide frequency diversity and anywhere from full “transmit base station” and receive-antenna space-diversity to schemes with no space diversity but very high-data rates.

One embodiment of the invention exploits intelligent wideband transmission of the information bearing signal over the multiple independently fading paths from each transmitting base station to a receiver in such a way that it provides the frequency diversity available in the transmission bandwidth, receive antenna diversity if multiple receive antennas are employed, extended coverage and high data rates. In one embodiment, communication between the base stations and mobile receivers in a wireless communication system occurs using transmission techniques that employ

an outer code, e.g., consisting of an binary code, such as a rate-compatible convolutional code, together with a bit-interleaver, a mapper and a modem, yielding bit-interleaved coded modulation.

A wireless communication system a first device (e.g., a base station) having a transmitter and a second device having a receiver (e.g., a mobile terminal) to receive information-bearing signals from the transmitter wirelessly transmitted using OFDM and bit interleaved coded modulation is described. In one embodiment, the communication system described herein is a coded modulation system that includes transmitters that apply space-time coding with bit-interleaved coded modulation that is combined with a multi-carrier OFDM modulation and receivers that apply OFDM demodulation with iterative demapping and decoding. The systems described herein have Nₜ transmit antennas and Nᵣ receive antennas. Each of the Nᵣ receive antennas receives signals that are the sum of channel-distorted versions of the signals transmitted from the Nₜ transmit antennas. Such coded modulation systems in accordance with the present invention may be advantageously employed in wireless local/wide area network (LAN/WAN) applications.

While the exemplary embodiment is described for space-time coding with bit-interleaved coded modulation, other types of coded modulation for space-time coding may be used. In addition, the exemplary embodiments are described for a mapping of the bit-interleaved coded data into symbols using QAM; however, other modulation schemes may be used, such as, for example, but not limited to phase-shift keying (PSK).

Generally, the receiver includes circuitry that estimates the values for the elements in channel response matrix Hₖ, and such estimates may be generated using periodic test (pilot) signals transmitted by the transmitter to the receiver. Such a priori information of the channel impulse response may also be generated via simulations. The matrix Hₖ denotes the channel response over the kth OFDM tone and is a matrix of dimensions Nᵣ by Nₜ. In other words, periodic test signals are used to obtain channel (condition) information.

In one embodiment, transmission of signals in the wireless communication system is controlled by a controller. The controller manages the information flow (signals) to and from the involved base stations/transmit antennas as well as channel identification algorithms. The controller is described in more detail below.

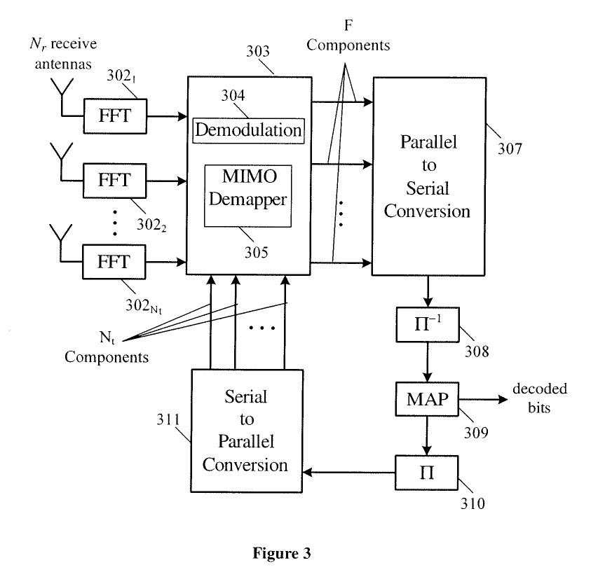

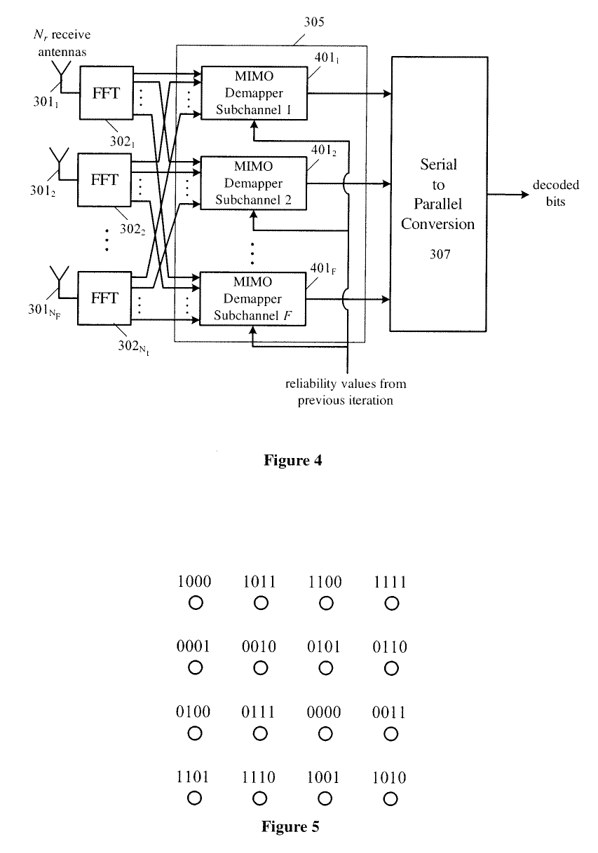

In one embodiment, a receiver consists of a joint modem demapper unit, a deinterleaver and a maximum a posteriori (MAP) probability decoder for the outer convolutional code. In one embodiment, iterative decoding is used with the demapper (in the decoder shown in FIGS. 3 and 4) as SISO 1 (soft in, soft out). In one embodiment, the demapper SISO 1 is a demapper described in Papadopoulos & Sundberg, “A Method and Apparatus for Efficient Wideband Transmission from Multiple Non-Collocated Base Stations over Wireless Radio Networks,” provisional patent application No. 60/861,539, filed Nov. 28, 2006, which is incorporated by reference. In one embodiment, a SISO 2 decoder for the outer convolutional code (or the RCPC code in the UEP case) is a MAP (BCJR) or a maxlog MAP decoder. Thus, in one embodiment, iterative decoding using the joint demapper as the inner MAP decoder occurs. Note that with the outer code and interleaver, some frequency diversity is obtained when communicating over frequency selective channels, since the interleaving and coding takes place also in the frequency domain as well as in the time domain. The receiver operates over those frequencies. The outer binary code may also be an LDPC code or a turbo code.

In one embodiment, non-iterative receivers that are based on the (hard-output) Viterbi algorithm correspond to reduced-complexity options that are used in the receiver. In one embodiment, the receiver is a sub-optimum receiver having a demapper followed by a Viterbi decoder (instead of a MAP decoder and no iterative decoding). This receiver has inferior performance to that of the iterative decoding (ID) algorithm, but it also has lower decoding complexity.

### An Example of a Two-Based Station Embodiment

Embodiments of the invention provide for reliable high-throughput wideband transmission of an information-bearing signal from multiple transmit base stations to one or more mobile users without the need for synchronizing the transmissions. In particular, it provides a method and apparatus for asynchronous transmission and reception of the same signal through multiple base stations, so that any receiver can reliably decode the sequence.

In one embodiment, a base station-based communication system comprises an encoder at the transmission side and decoding at the receiver designed to decode data encoded using the encoder. As disclosed above, in one embodiment, the encoder consists of outer/inner code structure, wherein the inner code is a mapper for the modem in the OFDM system, and the bit-interleaved coded modulation is employed by use of an outer binary convolutional code, where the rate of the outer code can be quite high, e.g., 9/10. In such a case, there would be little or no space diversity but very high throughput. The teachings described herein apply to any outer code rate and the rate is a design parameter. A decoding algorithm for reliably decoding information-bearing symbols at any mobile receiver based on the received signals transmitted from multiple base-stations, comprises joint demapper and a decoder for the outer code (with or without iterative decoding), where the outer code could be any binary code, e.g., a convolutional code, an RCPC code for UEP, a Turbo code, or an LDPC code.

FIG. 1 illustrates an asynchronous wireless wideband transmission from multiple base stations to mobile receivers (terminals). Referring to FIG. 1, multiple base stations 102₁-102ₙ are shown, and each of these base stations has, potentially, multiple antennas for communicating with mobile receivers, such as mobile receiver 103. In one embodiment, each transmitting base station of base stations 102₁-102ₙ has available the same information-bearing symbol stream that is to be communicated to the receiver(s) 103 along with coding parameters as described above to enable transmission of the stream from different antennas on different base stations.

Central controller 101 is communicably coupled to base stations 102₁-102ₙ to control base stations 102₁-102ₙ. In one embodiment, controller 101 manages the information flow (signals) to and from the involved base stations/transmit antennas as well as channel identification algorithms. Controller 101 selects the transmit antennas and base stations from a collection of available base stations. In one embodiment, controller 101 communicates with the (transmitting) base stations 102₁-102ₙ via wire (or wireless broadcast). Note that the signals transmitted from any two antennas (whether the antennas reside on the same or on different base stations) are typically not the same, just as is the case with existing space time code designs for systems with collocated transmit antennas.

In one embodiment, controller 101 controls the asynchronous wideband transmission from non-collocated antennas residing at multiple base stations, such as base stations 102₁-102ₙ. In such a case, controller 101 signals multiple base stations at a time. This allows more users to be served with higher rates at the same quality without an increase in bandwidth. This also allows the same users at the same throughput to have more reliability without an increase in bandwidth. More specifically, controller 101 performs antenna selection and selects the number of transmit antennas (located over multiple base stations) to use. The antenna selection improves performance against outages, while the use of more transmit antennas improves reliability at the same rate.

In one embodiment, controller 101 controls a set of antenna elements dispersed over multiple, non-collocated base stations 102₁-102ₙ to wirelessly transmit information-bearing signals to one or more receivers using space-time coding. Controller 101 includes an antenna selection control unit 101A that is operable to select non-collocated antenna elements from the set of antenna elements to send a signal to a receiver in the wireless communication system from antenna elements located at different base stations. In one embodiment, antenna selection control unit 101A allocates different antennas for different users and allocates OFDM tones to different users.

In one embodiment, antenna selection control 101A selects antenna elements based on channel condition information 110 determined with respect to wireless transmission to the receiver. In one embodiment, channel condition information 110 comprises signal strength information corresponding to signals received by the receiver. In another embodiment, channel condition information 110 comprises signal-to-noise ratio (SNR) information corresponding to signals received by the receiver. In either case, channel condition information is collected and provided to controller 101 from one or more of the base stations 102₁-102ₙ in response to pilot (test) signals sent from base stations to individual receivers in a manner well-known in the art. Thus, channel information is used to determine the adaptability of the wireless communication system.

In one embodiment, the antenna selection is based on SNR based information from antenna pairs collected by base stations and passed along to controller 101. In one embodiment, antenna selection control 101A selects antenna elements from the set of antenna elements based on desired data rate and desired diversity information 111 with respect to the receiver. Antenna selection control 101A weighs the desired rate against the desired level of diversity to determine which antenna elements to use to transmit a particular signal to a particular receiver. Thus, the selection by antenna selection control 101A includes a determination of how each set of non-collocated antennas for each user will impact (interfere) with the set(s) of non-collocated antennas being used for other users.

In one embodiment, antenna selection control 101A selects antenna elements jointly based on channel condition information 110 with respect to wireless transmission to multiple receivers in the wireless communication system. Thus, in such a case, antenna selection control 101A selects antenna elements for multiple users (receivers) jointly over multiple base stations.

Note that in one embodiment, antenna selection control 101A selects between antenna elements of each base station. Therefore, if the controller is only going to use two transmit antennas, one from each of two base stations, antenna selection control 101A selects between the different combinations of the transmit antenna elements at the two base stations.

In one embodiment, controller 101 performs channel identification algorithms, in a manner well known in the art. The channel identification algorithm(s) could be straightforward extensions of existing techniques that are used by scheduling algorithms to simultaneously schedule transmissions to multiple users. These techniques exploit crude channel information (crude in the sense that it is a quantized SNR level for the given transmit-receive antenna pair and may be apply to a block of tones.)

Note that the same receiver structures can be used as are used in collocated antenna systems (although their performance will be different). Receivers that may be used include those described in U.S. patent application Ser. No. 12/121,634 entitled “Adaptive MaxLogMAP-Type Receiver Structures,” filed on May 15, 2008 and U.S. patent application Ser. No. 12/121,649, entitled “Adaptive Soft Output M-Algorithm Receiver Structures,” filed on May 15, 2008, but other receivers may be used.

### Transmitter and Receiver Embodiments

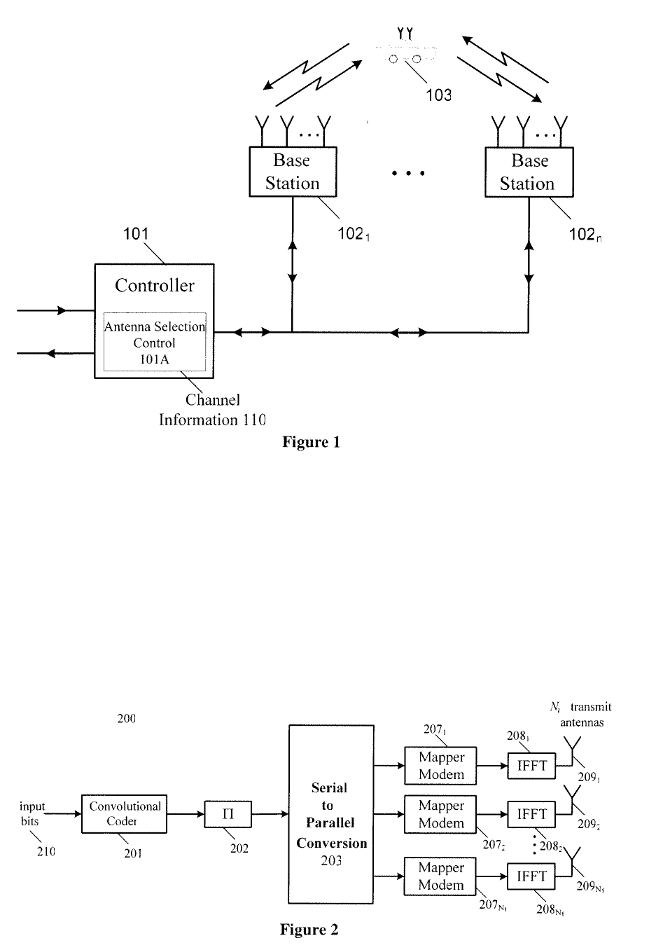

FIGS. 2 and 3 show the transmitter and receiver block diagrams for a MIMO/OFDM system with BICM and ID. More specifically, FIG. 2 is a block diagram of one embodiment of a transmitter for space-time coding with bit-interleaved coded modulation (BICM) with OFDM modulation for wideband frequency selective channels. Referring to FIG. 2, transmitter 200 comprises convolutional encoder 201, bit interleaver 202, serial-to-parallel converter 203, mapper modems 207₁-207_{Nt}, inverse fast Fourier transform (IFFT) modules 208₁-208_{Nt}, and transmit antennas 209₁-209_{Nt}. Note that IFFT modules 208₁-208_{Nt} also include circular-prefix operations, which are performed in a manner that is well-known in the art.

To perform BICM encoding to the data, convolutional coder 201 applies a binary convolutional code to the input bits (input data) 210. Bit interleaver 202 then interleaves the encoded bits from convolutional coder 201 to generate BICM encoded data. This bit interleaving de-correlates the fading channel, maximizes diversity, removes correlation in the sequence of convolutionally encoded bits from convolutional coder 201, and conditions the data for increased performance of iterative decoding. Convolutional coder 201 and bit interleaver 202 may typically operate on distinct blocks of input data, such as data packets.

After performing BICM encoding, OFDM is applied to the BICM encoded data. Serial-to-parallel converter 203 receives the serial BICM encoded bitstream from bit interleaver 202. Note that serial-to-parallel converter 203 may include a framing module (not shown) to insert framing information into the bitstream, which allows a receiver to synchronize its decoding on distinct blocks of information. Serial-to-parallel converter 203 generates a word of length Nt long, with each element of the word provided to a corresponding one of mapper modems 207₁-207_{Nt}. Elements of the word may be single bit values, or may be B bit values where B is the number of bits represented by each modem constellation symbol.

Each of mapper modems 207₁-207_{Nt} convert B bits to corresponding symbols (of the Q-ary symbol space, with Q=2^{B}). The output of each modem mapper 207 is a symbol. Each of IFFT modules 208₁-208_{Nt} collect up to F symbols, and then apply the IFFT operation of length F to the block of F symbols. F is an integer whose value can typically range from as small as 64 to 4096, or larger and depends on the available transmission bandwidth, the carrier frequency, and the amount of Doppler shifts that need to be accommodated by the system. Thus, each of IFFT modules 208₁-208_{Nt} generate F parallel subchannels that may be transmitted over corresponding antennas 209₁-209_{Nt}. Each subchannel is a modulated subcarrier that is transmitted to the channel.

In one embodiment, when the controller performs antenna selection, the controller causes different streams output from serial-to-parallel converter 203 to be shifted to different antennas, including those at different base stations. The controller can provide to each base station the coded substreams that it needs to transmit along with the physical antenna indices, but it can also broadcast the uncoded data bits along with coding parameters and antenna selection parameters

In one embodiment, the controller of FIG. 1 communicates the information bearing stream 210 to each base-station along with the coding parameters (rate of the outer code, initialization seed in the pseudorandom interleaver, constellation size, mapper lookup table, and possibly, FFT size and circular-prefix size, if these can vary). Then, once the antenna selection process is complete, the controller sends sets of pairs of numbers to each base station. In one embodiment, each such pair is of the form (x,y), implying that the stream produced for the xth antenna in FIG. 2 should be transmitted over physical antenna with index y at the given base station. In another embodiment, the controller communicates, to each base station, pairs of the form (xth stream, physical antenna index y). The xth stream in this case could be the input or the output stream of mapper module 207ₓ (if it is the input, the controller should be make sure that the base station has available the mapper lookup table so as to be able to generate the associated output stream).

FIG. 3 is a block diagram of one embodiment of a receiver having an iterative decoder for the space-time code for the OFDM system. Referring to FIG. 3, receiver 300 comprises receive antennas 301₁-301_{Nr}, fast Fourier transform (FFT) modules 302₁-302_{Nr}, demodulator/detector 303, parallel-to-serial converter 307, bit deinterleaver 308, maximum a posteriori (MAP) decoder 309 (e.g., a BCJR decoder), bit interleaver 310, and serial-to-parallel converter 311. Although not shown, each of the FFT modules 302₁-302_{Nr} is preceded by front end that performs filtering, band-rate sampling, and a circular-prefix-removal operation.

For a wideband system, receiver 300 performs OFDM demodulation for each of receive antennas 301_{1-Nr}, and the demodulation and demapping is performed over F parallel subchannels. The ith receive antenna 301(i) senses a signal made up of various contributions of the signals transmitted from the Nₜ transmit antennas (i.e., contributions of the multiple F parallel, narrowband, flat fading subchannels transmitted over corresponding antennas 209₁-209_{Nt} of FIG. 2). Each of FFT modules 302₁-302_{Nr} apply an F-point FFT to the corresponding signals of receive antennas 301₁-301_{Nr}, generating Nᵣ parallel sets of F subchannels.

In one embodiment, demodulator/detector 303 estimates bits in each of the F subchannels (slowly varying with flat fading) rather than in only one subchannel as in the narrowband, flat fading systems of the prior art. Demodulator 304 demodulates F subchannel carriers to baseband for each of the Nᵣ parallel sets of F subchannels. Multi-input multi-output (MNO) demapper 305, based on the Nᵣ parallel sets of F subchannels from FFT modules 302₁-302_{Nr} produces MAP estimates of the demapped bits (i.e, bits mapped from the constellation symbol) in each of the F subchannels from the Nt antennas in the transmitter. MIMO demapper 305 produces the estimates of the demapped bits and reliability information about these bits using reliability information generated by soft-output decoding (followed by reinterleaving) by MAP decoder 309.

In one embodiment, MIMO demapper 305 computes soft values for bits that comprise the constellation symbols transmitted over the Nₜ antennas on the non-overlapping F subchannels, along with an estimate (approximation) of the posteriori probability of the soft value being correct. This is performed in a manner well-known in the art.

In one embodiment, MIMO demapper 305 considers all combinations of bits comprising the Nₜ constellation symbols tranmitted over a subchannel and then evaluates each combination.

FIG. 4 is a block diagram of one embodiment of MINTO demapper 305 having MIMO joint demapper units for the different OFDM tones/subchannels. Referring to FIG. 4, each signal of the Nᵣ receive antennas 301₁-301_{Nr} is divided into F subchannels (via demodulator 304, not shown in FIG. 4) by applying the FFT and sent to corresponding subchannel MIMO demappers 401₁-401_{F}. The signal outputs of the kth subchannel for all Nr receive antennas are provided to the kth subchannel MIMO demapper 401(k), reliability information using extrinsic information generated from the output of MAP decoder 309 of the previous iteration. The extrinsic information is exchanged between MIMO demapper 305 and MAP decoder 309 to improve the bit error rate performance for each iteration in a manner well-known in the art.

Returning to FIG. 3, the estimates of bits in F parallel streams from MIMO demapper 305 together with reliability values for those bits are provided to parallel-to-serial converter 307 which reconstitutes the estimate of the BICM encoded bitstream generated by the transmitter, which was estimated by the receiver 300. The estimated BICM encoded bitstream is then deinterleaved by bit deinterleaver 308 and applied to MAP decoder 309 to decode the information-bearing signal (this is the decoder that is associated with the convolutional encoding applied by the transmitter).

MAP decoder 309 performs the MAP decoding process to generate soft output values for transmitted information bits in a manner well-known in the art. By performing an iterative process with MIMO demapper 305, the soft output values may become more reliable.

The extrinsic information from MAP decoder 309 is first applied to bit interleaver 310. Bit interleaving aligns elements of the extrinsic information with the interleaved estimated BICM encoded bitstream from MIMO demapper 305. In addition, the interleaved extrinsic information is applied to serial-to-parallel converter 311, which forms Nₜ parallel streams of extrinsic information corresponding to the parallel bit streams formed at the transmitter. The extrinsic information is exchanged between MIMO demapper 305 and MAP decoder 309 to improve the bit error rate performance for each iteration, in a manner that is well-known in the art. For more information, see U.S. patent application Ser. No. 12/121,634 entitled “Adaptive MaxLogMAP-Type Receiver Structures,” filed on May 15, 2008. Also, the MIMO demapper 305 can be MAP, MaxLogMap, improved MaxLogMAP, SOMA, or any other reduced-complexity inner-demapper algorithm.

FIG. 5 illustrates one embodiment of a so called set partition type mapper for 16 QAM for use in iterative decoding. This is used for mapping the bit-interleaved coded data into symbols.

Note that the techniques described herein for a low complexity receiver need not be limited to a system employing OFDM modulation.

### Advantages of Embodiments of Invention

By employing space-time coded transmission via a set of transmitter antennas distributed over multiple (non-collocated) base stations, extended coverage and reliability and/or improved data rates can be achieved. Embodiments of the invention allow opportunistic diversity/reliability/range improvements in communicating information-bearing signals to one or more receivers over a wireless channel, by exploiting the availability of the information at multiple base stations. This reliability improvement comes at minimal cost in total transmit power per symbol, and can be trade-off for improved data rates (using a high-rate outer code), or superior coverage. Given an arbitrary set of transmitting base stations, the schemes described can provide full transmit base-station diversity benefits regardless of the relative delays between transmissions provided the outer code rate is low (at most 1 over the number of transmit antennas). At the other extreme, these schemes can provide very high data rates (with limited space diversity) by using a high rate outer code. Also, by using a long enough circular prefix in the OFDM transmission to accommodate for the maximum possible relative delays in reception between transmissions from distinct base stations, no synchronization between the transmissions from distinct base stations is required. That is, the circular prefix is a priori chosen so as to accommodate the longest relative delays in paths arriving from signals transmitted from any pair of transmit antennas. This selection of the circular prefix is done in a manner well known in the art.

The use of an outer binary convolutional code and bit interleaving result in efficient and robust systems for wideband transmission that also harvest the frequency diversity that is available in the transmission band. However, for reception, suboptimum low-complexity decoding may be used at the receiver. Moreover, iterative decoding can also be employed with the demapper as the inner decoder and the outer decoder being a MAP or MaxLogMAP decoder for the RCPC code; even in the case of communication over flat fading channels, the iterative decoding structure can provide performance benefits. Other outer binary codes can also be used, including LDPC codes and turbo codes, in a manner well-known in the art. In either case, a soft-output decoder is used for the associated outer binary code being employed.

Furthermore, the techniques describe herein can be easily modified to include flexible unequal error protection for media signals. That is, the use of an RCPC code as the outer binary convolutional code yields flexible UEP properties. The entire system is quite flexible and robust to changes in the number of transmit and receive antennas as well as modem constellations.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A wireless communication system comprising:
a controller to control a set of antenna elements dispersed over multiple, non-collocated base stations to wirelessly transmit information-bearing signals to one or more receivers using OFDM transmission, wherein control unit includes an antenna selection control operable to select non-collocated antenna elements from the set of antenna elements to send at least one signal to a receiver in the wireless communication system from antenna elements located at different base stations, and further wherein the OFDM transmission occurs with use of a circular prefix long enough to accommodate a maximum possible relative delay in reception between transmission from the antenna elements located at the different base stations.

2. The wireless communication system defined in claim 1 wherein the antenna selection control of the controller selects antenna elements from the set of antenna elements based on channel condition information with respect to wireless transmission to the receiver.

3. The wireless communication system defined in claim 2 wherein the antenna selection control of the controller selects antenna elements from the set of antenna elements based on desired data rate and desired diversity with respect to wireless transmission to the receiver.

4. The wireless communication system defined in claim 2 wherein the channel condition information comprises signal strength information corresponding to signals received by the receiver that is provided to the controller from one or more of the base stations.

5. The wireless communication system defined in claim 2 wherein the channel condition information comprises signal-to-noise ratio (SNR) information corresponding to signals received by the receiver that is provided to the controller from one or more of the base stations.

6. The wireless communication system defined in claim 2 wherein the antenna selection control of the controller selects antenna elements from the set of antenna elements based on channel condition information with respect to wireless transmission to one or more other receivers in the wireless communication system.

7. The wireless communication system defined in claim 6 wherein the antenna selection control of the controller selects antenna elements from the set of antenna elements jointly for the receiver and at least one of the one or more other receivers.

8. The wireless communication system defined in claim 1 wherein the non-collocated base stations wirelessly transmit the information-bearing signals using an outer binary convolutional code that is based on bit-interleaved coded modulation.

9. The wireless communication system defined in claim 8 wherein the outer binary convolutional code that is based on bit-interleaved coded modulation is combined with OFDM transmission.

10. The wireless communication system defined in claim 1 further comprising a transmitter to send information-bearing signals to the receiver wirelessly using a space-time encoding system comprising:
an outer binary code;
a bit interleaver; and
a modem and a mapper combined with an OFDM transmission system.

11. The wireless communication system defined in claim 10 wherein the outer binary code is a rate-compatible punctured convolutional (RCPC) outer code.

12. The wireless communication system defined in claim 10 wherein the outer binary code is a LDPC code.

13. The wireless communication system defined in claim 10 wherein the outer binary code is a turbo code.

14. The wireless communication system defined in claim 10 wherein the receiver comprises:
a demapper having a soft output joint demapping unit for each subchannel in the OFDM system;
a deinterleaver communicably coupled to the demapper; and
an outer decoder of MAP type for the outer binary code.

15. A method comprising:
receiving channel condition information with respect to wireless transmission to a receiver in a wireless communication system having a set of antenna elements dispersed over multiple, non-collocated base stations to wirelessly transmit information-bearing signals to one or more receivers using OFDM transmission;
selecting non-collocated antenna elements from the set of antenna elements to send at least one signal to a receiver in the wireless communication system from antenna elements located at different base stations;
using a circular prefix in the OFDM transmission long enough to accommodate a maximum possible relative delay in reception between transmission from the antenna elements located at the different base stations; and
matching signal elements to the transmit antennas at one or more base stations

16. The method defined in claim 15 wherein selecting non-collocated antenna elements is based on one or more of a group consisting of desired data rate and/or desired diversity, both with respect to wireless transmission to the receiver.

17. The method defined in claim 15 wherein the channel condition information comprises signal strength information corresponding to signals received by the receiver that is provided from one or more of the base stations.

18. The method defined in claim 15 wherein the channel condition information comprises signal-to-noise ratio (SNR) information corresponding to signals received by the receiver that is provided from one or more of the base stations.

19. The method defined in claim 15 wherein selecting antenna elements from the set of antenna elements is based on the channel condition information with respect to wireless transmission to a plurality of receivers in the wireless communication system including the receiver.

20. The method defined in claim 19 wherein selecting antenna elements from the set of antenna elements comprises jointly selecting antenna elements from the set of antenna elements for the receiver and at least one of the one or more other receivers based on the channel condition information.

21. The method defined in claim 15 wherein the non-collocated base stations wirelessly transmit the information-bearing signals using an outer binary convolutional code that is based on bit-interleaved coded modulation.

22. The method defined in claim 21 wherein the outer binary convolutional code that is based on bit-interleaved coded modulation is combined with OFDM transmission.

23. The method defined in claim 22 wherein the outer binary code is a rate-compatible punctured convolutional (RCPC) outer code.

24. The method defined in claim 22 wherein the outer binary code is a LDPC code.

25. The method defined in claim 22 wherein the outer binary code is a turbo code.
